(19) United States
(12) Patent Application Publication
(10) Pub. No.: US 2002/0079169 A1
(43) Pub. Date: Jun. 27, 2002

(54) BRACKET FOR SECURING ELEVATOR COMPONENTS

(76) Inventor: RAYMOND MONCINI, SOUTHINGTON, CT (US)

Correspondence Address: OTIS ELEVATOR COMPANY, INTELLECTUAL PROPERTY DEPARTMENT, 10 FARM SPRINGS, FARMINGTON, CT, 06032, US

(21) Appl. No.: 09/407,032

(22) Filed: Sep. 27, 1999

(51) Int. Cl. B66B 7/06

(52) U.S. Cl. 187/408; 187/266; 187/411

(57) ABSTRACT

An elevator component mounting system includes one or more bracket-beam type structures that spans the vertical distance between successive floor slabs to provide a support bracket for elevator components in the absence of a vertical wall spanning the floor slabs. The bracket-beam structure is suitable for mounting dead-end rope hitches, elevator machines and other components.

### TECHNICAL FIELD

The present invention relates to elevator systems and, more particularly, to a bracket for securing elevator components, such as dead-end hitches, to a hoistway having limited wall area available for attachment.

### BACKGROUND OF THE INVENTION

Elevator systems are typically installed in vertical hoistways within buildings having structural characteristics particularly dimensioned and designed to accommodate the elevator system components. Such customized design and structure are costly and space-consuming. In addition, permanent structures cannot be easily or inexpensively altered and, thus, replacement options for old or damaged elevator equipment are limited. Additionally, such permanent structures sometimes prohibit convenient access to various elevator components for servicing or repair.

Most elevator component mounting devices for mounting in the hoistway require an available section of hoistway wall spanning successive floor slabs to support mounting. It is desirable in many building structures, however, to forego constructing such wall spans unless necessary.

### OBJECTS AND SUMMARY OF THE INVENTION

It is an object of the present invention to provide an elevator component mounting system that enables an elevator system to be installed in a building that does not require costly or space-consuming structural characteristics.

It is another object of the present invention to provide an elevator component mounting system that is versatile with respect to its interfacing with different building structures and with different elevator components.

It is another object of the present invention to provide an elevator component mounting system that spans successive floor slabs and does not require a continuous hoistway wall span to support it.

It is yet another object of the present invention to provide an elevator component mounting system that facilitates convenient access to various elevator components for servicing or repair.

These objects and others are achieved by the present invention mounting system disclosed herein.

The present invention elevator component mounting system is directed to one or more bracket-beam type structures that span the vertical distance between successive floor slabs to provide a support bracket for elevator components in the absence of a vertical wall spanning the floor slabs. The bracket-beam structure according to the present invention is suitable for mounting dead-end rope hitches, elevator machines and other components. In the preferred embodiment, the present invention is described with respect to a system that includes two bracket-beam structures on opposite sides of a hoistway wherein each bracket-beam structure supports a rope dead-end hitch and one bracket-beam structure supports an elevator machine.

### BRIEF DESCRIPTION OF THE DRAWINGS

FIG. 1 partial, schematic side view of a preferred embodiment an elevator component support system according to the present invention shown supporting rope dead-end hitches and an elevator machine.

FIG. 2 is a partial, schematic, top cross-sectional view of a component of the embodiment shown in FIG. 1.

### DESCRIPTION OF THE PREFERRED EMBODIMENT

A preferred embodiment of the present invention elevator component supporting system (10) includes a first beam (12) and a second beam (14). Each beam (12, 14) is an elongated, rigid member that may have any one of a variety of cross-sectional shapes such as rectangular, as shown in FIG. 2. Each beam (12, 14) is attached to an upper and lower floor slab (16, 18, respectively) representing two successive floors in a building structure. The first beam (12) is attached to the floor slabs (16,18) by a set of upper and lower brackets (20, 22) that may be attached to the floor slabs (16, 18) by bolts (22). The second beam (14) is attached to the floor slabs (16,18) by a set of upper and lower brackets (24, 26) that may be attached to the floor slabs (16, 18) by bolts (22).

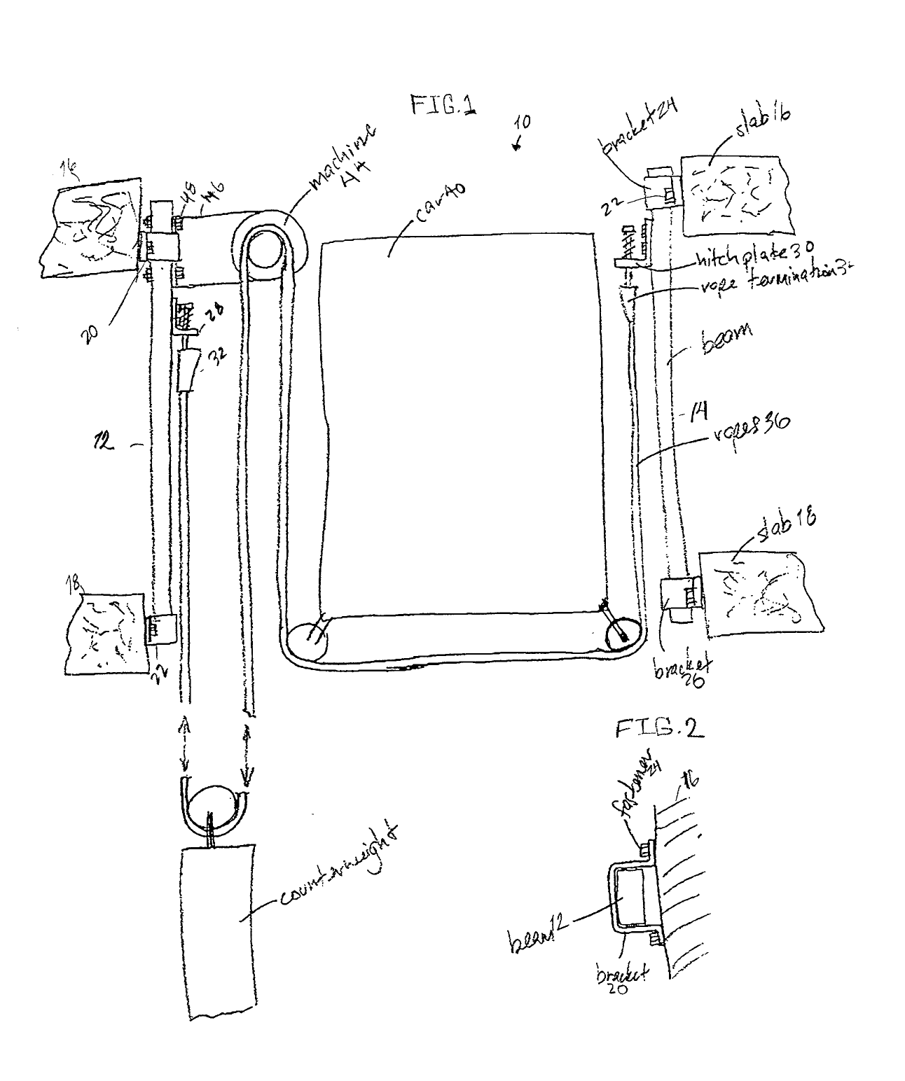

A variety of elevator components may be attached to the beams (12, 14) of the present invention. In the preferred embodiment, rope dead-end hitch plates (28, 30) may be attached, respectively, to the beams (12, 14) as shown in FIG. 1. The hitch-plates (28, 30) anchor rope terminations (32, 34) for elevator ropes (36) that, as shown, suspend an elevator car (40) and a counterweight (42) for movement. An elevator machine (44) is mounted to the first beam (12) through its machine bracket (46) that is attached with bolts (48) to the first beam (12).

While the preferred embodiment of the present invention has been herein described, it is understood that variation and modification can be made without departing from the scope of the presently claimed invention.

What is claimed is:

1. an elevator component mounting system for mounting elevator components within an elevator hoistway between two vertically-spaced structural building members, said system comprising
a first elongated, rigid member having a first end and a second end; and
attachment means at each of said first and second ends for attaching said first rigid member at each end to one of said two vertically-spaced structural building members, respectively, so that said first rigid member extends across a span between said two vertically-spaced structural members.

2. A system according to claim 1, further comprising
rope hitch attachment means for attaching an elevator rope end to said first rigid member.

3. A system according to claim 1, further comprising
elevator machine mounting means for mounting and elevator machine to said first rigid member.

4. A system according to claim 1, further comprising
a second elongated, rigid member having a first end and a second end; and
attachment means at each of said first and second ends for attaching said second rigid member at each end to one of said two vertically-spaced structural building members, respectively, so that said second rigid member extends across a span between said two vertically-spaced structural members.

5. A system according to claim 4, wherein said first elongated, rigid member and said second rigid member are positioned opposite from each other, at generally the same vertical position, within said elevator hoistway.

6. A system according to claim 4, further comprising elevator machine mounting means for mounting an elevator machine to said first rigid member.

7. A system according to claim 5, further comprising rope hitch attachment means associated with each of said first and said second rigid members for attaching an elevator rope end to each of said first and said second rigid members, respectively.

8. An elevator rope attachment system for attaching the ends of an elevator rope within an elevator hoistway between two vertically-spaced structural building members, said system comprising
a first elongated, rigid member having a first end and a second end;
first rigid member attachment means at each of said first and second ends for attaching said first rigid member at each end to one of said two vertically-spaced structural building members, respectively, so that said first rigid member extends across a span between said two vertically-spaced structural members;
a second elongated, rigid member having a first end and a second end;
second rigid member attachment means at each of said first and second ends for attaching said second rigid member at each end to one of said two vertically-spaced structural building members, respectively, so that said second rigid member extends across a span between said two vertically-spaced structural members; and
rope hitch attachment means on each of said first and said second rigid members for attaching the ends of said elevator rope end to each of said first and said second rigid members, respectively.

9. A system according to claim 8, further comprising elevator machine mounting means for mounting an elevator machine to said first rigid member.

10. An elevator component mounting apparatus for mounting elevator components within an elevator hoistway between two vertically-spaced structural building members, said apparatus comprising
a first elongated, rigid member having a first end and a second end; and
attachment means at each of said first and second ends for attaching said first rigid member at each end to one of said two vertically-spaced structural building members, respectively, so that said first rigid member extends across a span between said two vertically-spaced structural members.

11. An elevator system having a car moving within a hoistway, the hoistway having a plurality of support slabs vertically spaced through the hoistway, the elevator system including:
one or more ropes engaged with the car to carry the load of the car such that tension is produced in the ropes; and
a support assembly engaged with one or more ropes and attached to one or more of the support slabs to transfer the tension from the ropes to one or more support slabs.

12. An elevator system according to claim 11, wherein the one or more ropes have at least one end that is attached to the support assembly.

13. An elevator system according to claim 11, further including a machine engaged with the ropes to drive the car through the hoistway, wherein the machine is attached to the support assembly such that the tension load in the ropes are passed through the machine and to the support assembly.

14. An elevator system according to claim 11, wherein the support assembly includes a member extending between vertically spaced support slabs such that loads are shared between the support slabs.
